(19) United States
(12) Patent Application Publication
(10) Pub. No.: US 2005/0107525 A1
(43) Pub. Date: May 19, 2005

(54) Coating/pretreatment composition and methods of using the same

(76) Inventor: David Gregg Lawson, Lake Elsinore, CA (US)

Correspondence Address: LAINIE E. PARKER;AKZO NOBEL INC., 7 LIVINGSTONE AVENUE, DOBBS FERRY, NY, 10522-3408, US

(21) Appl. No.: 10/988,445

(22) Filed: Nov. 12, 2004

Related U.S. Application Data
(60) Provisional application No. 60/519,841, filed on Nov. 13, 2003.

(51) Int. Cl. B05D 3/00; C08K 3/00

(52) U.S. Cl. 524/589; 427/299; 427/402

(57) ABSTRACT

The invention relates to coating/pretreatment compositions and methods of using the same. The coating/pretreatment composition includes a polyurethane or polyurea dispersion (PUD), with one or more crosslinkers (e.g., melamine, blocked isocyanate, phenolic resin, etc.) and an epoxy and/or acrylic resin, i.e., an epoxy, acrylic or an epoxy/acrylic resin. The composition can also include triethanolamine.

This application claims priority from U.S. Provisional Application No. 60/519,841, filed Nov. 13, 2003.

The present invention relates to a coating/pretreatment composition and methods of using the same. The composition can be used to protect any substrate, including any metal substrate, but the present inventor has only tried it on rolled up steel. Such rolls of steel are generally referred to as coils and coatings/paints used thereon are generally termed coil coatings. Production lines that apply organic coil coatings are generally referred to as Coil Coating Lines (CCLs). Production lines that apply metal coatings to steel are generally referred to as Metal Coating Lines (MCLs). This invention is applicable for both MCLs and CCLs.

### BACKGROUND OF THE INVENTION

Coating compositions applied by CCLs cannot usually be employed on MCLs because MCLs require a shorter resident time in the oven, lower curing temperature, and minimal, or no, volatile organic content. For example, pretreatment/sealer and primer compositions are applied on CCLs. However, it would be more efficient if these compositions could, instead, be applied on the MCL after the metal is galvanized. This would avoid having to remove the metal from the MCL and put it on the CCL in order to apply a pretreatment/sealer or primer composition. The present invention is directed to pretreatment/sealer and primer compositions that cure fast enough to be applied on a MCL, and methods for applying the same.

### SUMMARY OF THE INVENTION

The invention relates to coating/pretreatment compositions and methods of using the same. The coating/pretreatment composition includes a polyurethane or polyurea dispersion (PUD), with one or more crosslinkers (e.g., melamine, blocked isocyanate, phenolic resin, etc.) and an epoxy and/or acrylic resin, i.e., an epoxy, acrylic or an epoxy/acrylic resin. The composition can also include triethanolamine.

### DETAILED DESCRIPTION OF THE INVENTION

The inventive composition can be used as a coating on a variety of substrates and has been found to be particularly useful as a pretreatment or as a primer. For example, it can be used in place of conventional pretreatments, such as conversion coating pretreatments (e.g., zinc phosphate, mixed metal oxide, etc.) or dried-in-place pretreatments. Also, the composition functions as a sealer when it is applied to cleaned-only metal under a topcoat. Essentially, the composition can be applied and cured as if it were a dried-in-place pretreatment/sealer.

When steel is made on a first line, a Metal Coating Line (MCL), it may be zinc coated (known as hot-dipped galvanized (HDG)), coated with a zinc-aluminum mixture, e.g., GALVALUME® or ZINCALUME®, etc. Thereafter, the steel is pretreated, primed and sometimes finish-coated on a second line or Coil Coating Line (CCL).

In accordance with the invention, the inventive composition can be applied on the MCL and/or CCL and function as a pretreatment, primer, combination pretreatment/primer, sealer or other type of coating. For example, the inventive composition can be applied on a steel line (a MCL) as a sealer, pretreatment or as a combination pretreatment primer; it can be applied on a MCL as a primer on top of a pretreatment which was applied earlier on the same MCL; it can be applied on a coil line (a CCL) on either bare or pretreated steel to serve either as a sealer, pretreatment, a primer, or a combination primer/pretreatment, etc.

The most beneficial application of the present invention may depend on the particular problem to be solved. For example, in some cases, the steel is galvanized on the MCL and pretreated and primed on the CCL. Then, in order to apply the top/finish coating, the roll coated steel has to be unrolled and run through the CCL again. This can be time consuming. One of the benefits of the invention is that the steel can be pretreated on the same line on which it is galvanized (the MCL) using the inventive composition that has a quick curing time. Then, the CCL can be used to apply other coatings, e.g., a primer and a top/finish coating, a color coating and a clear coating, etc. This avoids having to unroll the coiled steel and run it through the second line again to apply another coating (e.g., the top/finish coating in the above example). This inventive method thus results in a low cost, economy production line.

Historically, finger print marks on metal were prevented using silicones or fluorocarbons and, more recently, nanotechnology. None of these are required in the present invention. In accordance with a method of the invention, finger print marks on metal and the related staining or corrosion that may result can be prevented by coating the metal with the inventive composition of PUD, melamine (and/or other crosslinkers) and an epoxy, acrylic or an epoxy/acrylic resin.

The composition is a waterborne polyurethane or polyurea dispersion (PUD). The inventive composition includes the PUD, one or more crosslinkers (e.g., melamine, blocked isocyanate, phenolic resin, etc.) and an epoxy and/or acrylic resin, i.e., an epoxy, acrylic or an epoxy/acrylic resin. A polyurethane dispersion is characterized by having polyurethane linkages. It is also not uncommon that during the preparation of the polyurethane dispersion that polyurea linkages are formed. Historically, it is also not uncommon that a solvent such as N-methyl pyrrolidone (NMP) is used in the preparation of the polyurethane dispersion. More recently, processes eliminating the need for such solvents have been developed and the resulting PUD can also be utilized in the present invention.

Representative examples of the epoxy/acrylic resin include an epoxy acrylate solution, an acrylic modified epoxy, an epoxy modified acrylic, etc. in these epoxy/acrylic resins, the epoxy group is no longer present because it is consumed when grafting with a functional group of the acrylic.

RECA 08 and RE0948 are representative examples of acrylic-grafted epoxies(an epoxy acrylate solution, acrylic modified epoxy, etc.) in which the acrylic is initially prepared as a solution polymer in solvent and then chemically grafted onto the epoxy through an esterification process (e.g., epoxy-carboxylic acid reaction). After reaction, the remaining carboxyl groups are amine salted and then dispersed in water rather than the latex process where monomers are dispersed in water and then polymerized. In an acrylic-grafted epoxy, the epoxy portion can be the sole source of hydroxyl functionality in which the hydroxyl groups are derived from the epoxy intermediate onto which the acrylic is grafted.

Representative examples of the epoxy resin include an emulsified epoxy or an epoxy dispersion. The composition can also include additives such as pigments, thickeners, defoamers, surfactants, pH adjustors, solvents, viscosity adjustors, etc.

With respect to the following resin components, PUD is the polyurethane or polyurea dispersion; RECA08 Epoxy Mod. Acrylic is an example of the epoxy, acrylic or an epoxy/acrylic resin; Phenolic Resin is an example of one type of crosslinker; and Methylated High Imino Melamine is an example of one type of crosslinker, as well as one type of melamine. Further, with respect to the following resin components, the following exemplary resin ratios are based on resin solids by weight:
PUD about 70-about 90%, e.g., 85.8%±4.5%
RECA08 Epoxy Mod. Acrylic about 2-about 15%, e.g., 2.9% ±0.3%
Phenolic Resin about 0-about 10%, e.g., 0.8%
Methylated High Imino Melamine about 5-about 15%, e.g., 10.5%±2%
   These ratios can be adjusted as long as the composition has a sufficient cure window in relation to dwell/temperature requirements. Preferably, the amount of crosslinker increases with increasing amounts of the epoxy and/or acrylic resin, but the amounts of PUD and epoxy and/or acrylic resin can be independently varied. Also, the ratios for the RECA08 Epoxy Mod. Acrylic and the Methylated High Imino Melamine are respectively applicable to the epoxy, acrylic or epoxy/acrylic resin and the melamine components of the composition. When a blocked isocyanate is included as a crosslinker, the amount can range from about 0 to about 30%, based on resin solids by weight. Further, when the blocked isocyanate is used with other crosslinkers, the amount can usually range up to about 20%, based on resin solids by weight.

The amount of additives, such as pigments, thickeners, defoamers, surfactants, pH adjustors, solvents, viscosity adjustors, etc. depends on the desired properties for the composition.

The inventive composition can be applied in any fashion for applying a pretreatment or coating, such as spray, brushed, dipped, etc. The present inventor has only tried reverse roll and direct roll (direction of the applicator roll relative to the movement of the coiled steel on the line) coating the composition because coil is always roll applied.

As discussed above, it is envisioned that the inventive composition can be applied to any substrate, which necessarily means it can be applied to any metal substrate as well. It can be applied to coated metal or bare metal. Representative examples include cold rolled steel, galvanized steel (HDG), zinc aluminum steel (e.g., GALVALUME® or ZINCALUME®) and aluminum.

One of the key features of the methods of the present invention is that the composition has a quick bake, generally about 2 to about 3 seconds, but it can even be less than 1 second. This is especially important when the composition is being used as a pretreatment which generally utilizes ovens shorter than those used in typical CCLs (e.g., ovens which may only be 3-5 feet long). In other words, the composition can be used on a CCL, but it is amenable to the high speed, fast cures of a MCL. Line speed and coating cure rate energy requirement are used to determine the oven length necessary.

The removal of water is one of the rate determining steps in the inventive methods. Water is present in the inventive composition due, at least in part, to the PUD being waterborne. Also, water is usually added at the coil coater to reduce viscosity to apply thinner films and affect film thickness control. The water in the applied wet film is removed during the curing/drying process. However, the amount of water sometimes results in blisters forming on the coating. One solution is to apply the composition using a 3-roll coater that utilizes higher application viscosities, as a result of higher solids content, i.e., less water is added as a reducer to adjust viscosity.

As a result of using a 3-roll coater, the following important benefits are expected to be realized:
1. faster, more complete cure of the applied film, i.e., higher line speeds in shorter ovens; and
2. better, more uniform film thickness control.
   These benefits are particularly pertinent where the composition is used as a roll-on pretreatment, which generally utilizes shorter ovens (e.g., only 3-5 feet long).

Once the composition is applied (e.g., as a pretreatment or primer), it can be baked using any means that provides sufficient heat. Generally, an oven is used, for example, an induction oven, infrared oven, near infrared (NIR) oven, convection oven, forced air oven, etc. Any oven with sufficient heat transfer would be appropriate. The preferred peak metal temperature (PMT) for the bake is about 212 to about 450° F. Generally, the PMT range is about 230 to about 270° F., e.g., for a forced air oven. Alternatively, the composition does have the ability to be cured at lower temperatures and may even be air dried.

It is hypothesized that the PUD is cured when the pretreatment/primer is baked and then, when the topcoat is baked, the melamine crosslinks with the epoxy and/or acrylic resin and some PUD as well. In the inventive composition, the epoxy and/or acrylic resin is essentially a source of hydroxy groups, i.e., a polymer with hydroxyl functionality. These hydroxy groups would crosslink with the crosslinker(s). The crosslinker(s) could further react with the amide hydrogens from the urethane and/or urea groups in the PUD.

The inventor has discovered that a particular benefit is obtained when triethanolamine is also included in the composition. The inventive composition does not require triethanolamine to operate as a pretreatment or coating composition. However, triethanolamine adds the benefits of reducing blisters, keeping the surface of the coating from prematurely drying/curing, and controlling the reaction rate for cross-linking the alkanolamine. Additionally, when the inventive composition includes triethanolamine, it is possible to use an acid catalyzed topcoat on the composition without the topcoat frosting/wrinkling or giving a sparkly/metallic effect.

A frosting/wrinkling or sparkly/metallic effect results when an acid catalyzed topcoat, such as a polyester, is used with a PUD primer or undercoating. This effect results from the amine in the PUD. Accordingly, it is quite surprising that adding more amine in the form of triethanolamine actually avoids a frosting/wrinkling or sparkly/metallic effect. It is hypothesized that the hydroxyl group on the triethanolamine also cross-links with the cross linker, e.g., melamine, in the composition.

The frosting/wrinkling or sparkly/metallic effect can depend on the ratio of volatile amine (e.g., triethylamine (TEA)) to non-volatile amine (e.g., triethanolamine (TEOA)). This amine ratio is based upon the amine content of the PUD.

The amount of triethanolamine (TEOA) can be calculated at 51.64% of the triethylamine (TEA) level, ±20-40% (or ±20% or ±40%). In example 1, this would be ˜5.66 lbs.±1-2lbs. TEOA per 100 gallons of formula or 207.74 lbs. PUD resin solids per 100 gallons of formula.

Another way to calculate the level of needed TEOA or non-volatile amine could be based upon the Acid number of the PUD with the following equation:
(mol. wt. non-volatile amine)×(acid number of PUD resin solids)×(wt. PUD resin solids)×0.3421/56,100=Wt. of Non-Volatile Amine, ±20-40% (or ±20% or ±40%).
This equation could then be used with similar PUDs and other non-volatile amines

Example calculation:
molecular wt. of TEOA=149
Acid number of PUD (on solids)=30
Weight solids of PUD=36% (In 100 gallons of the inventive composition there is 207.74 lbs of PUD resin solids)
149×30×207.74×0.3421/56100=5.66 lbs. (TEOA amount based upon the amount of PUD in 100 gallons of the inventive composition)
   Factoring in the ±40% range would then give a value of between 3.40-7.92 lbs. of non-volatile amine per 100 gallons on the total formula.

The pretreatment/coating composition is effective with or without pigments, such as strontium chromate or titanium dioxide. However, including strontium chromate in the composition imparts a benefit due to its anti-corrosive properties. These properties are realized in the absence of strontium chromate, but corrosion resistance is not as enhanced.

There is a potential for storage stability issues with respect to exposure of a coating composition to heat during transit or warehousing. This is especially the case when the coating composition has a low curing temperature and is capable of air drying, as is the pretreatment/coating composition of the present invention. This was overcome in the inventive composition by restricting the free solvent content to water only. The addition of free coalescing solvents can be especially detrimental to storage stability where heat is a factor.

Free coalescing solvents are solvents that can be substituted or removed from the formula. Solvents which are not free come into the formula with other materials and can only be maintained by managing the material which introduces them. For example, in the present formulation, PUD brings in NMP (or some other solvent in the NMP-free versions). The NMP level is determined by the level of PUD because it is contained exclusively in the PUD. Any additional NMP in the formulation would be considered free solvent.

### EXAMPLES

### Example 1

Standard

| | | |
|---|---|---|
| Item | Gal. | lbs. |

ADD THE FOLLOWING TO A CLEAN
STAINLESS VESSEL. ADD IN
ORDER UNDER COWLES AGITATION AT MEDIUM SPEED:

| | | |
|---|---|---|
| CYMEL 328 | 2.92 | 29.96 |
| DREWPLUS L-483 | 0.11 | 0.79 |
| SURFYNOL 465 SURFACTANT | 0.50 | 4.34 |
| DEIONIZED WATER | 2.45 | 20.42 |

MIX FOR 30 MINUTES THEN ADD THE FOLLOWING
UNDER HSD (high speed dispersion):

| | | |
|---|---|---|
| STRONTIUM CHROMATE 176 | 1.53 | 47.66 |
| TIONA RCL-6 | 0.48 | 15.60 |
| AEROSIL 200 | 0.04 | 0.75 |

HSD 30 MINUTES, THEN RECORD PREMIX VISCOSITY.
SPEC = 80-100 KU @ 77 F.
SANDMILL TO 7.0 + N.S.
RUN 2 PASSES
FIRST PASS GRIND REQUIREMENT: 6.0-6.5 NS
SECOND PASS GRIND REQUIREMENT: 7.0 + NS
AFTER THE GRIND IS APPROVED, USE THE NEXT
ITEM FOR THE FIRST MILL FLUSH:

| | | |
|---|---|---|
| DEIONIZED WATER | 2.08 | 17.33 |
| 2^{ND} MILL FLUSH: | | |
| DEIONIZED WATER | 2.08 | 17.33 |

LETDOWN WITH THE FOLLOWING
UNDER CONTINUOUS AGITATION.
MEDIUM SPEED PADDLE AGITATION IS PREFERRED.
ADD THE NEXT TWO ITEMS SLOWLY INTO THE VORTEX:

| | | |
|---|---|---|
| NEOREZ R-9637 | 65.57 | 577.05 |
| TRIETHANOLAMINE, 99% | 0.52 | 4.89 |

MIX FOR 15 MINUTES THEN CONTINUE BY ADDING
THE NEXT THREE ITEMS IN ORDER, SLOWLY
INTO THE VORTEX:

| | | |
|---|---|---|
| EPOXY MOD. ACRYLIC INTERMEDIATE | 4.10 | 35.12 |
| TRIETHYLAMINE | 0.40 | 2.45 |
| DEIONIZED WATER | 13.97 | 116.40 |

MIX 15 MINUTES THEN CONTINUE:

| | | |
|---|---|---|
| TRITON GR-7M SURFACTANT | 1.12 | 9.47 |
| ACRYSOL RM-825 | 1.01 | 8.82 |
| RHEOLOGY MODIFIER | | |

MIX 15 MINUTES THEN ADD:

| | | |
|---|---|---|
| TRIETHANOLAMINE, 99% | 0.42 | 3.99 |

HOLD THE NEXT TWO ITEMS FOR VISCOSITY ADJUSTMENT:

| | | |
|---|---|---|
| DEIONIZED WATER | 0.60 | 4.98 |
| ACRYSOL RM-825 | 0.00 | 0.01 |
| RHEOLOGY MODIFIER | | |

HOLD FOR PH ADJUSTMENT:

| | | |
|---|---|---|
| TRIETHYLAMINE | 0.02 | 0.10 |

HOLD FOR ELIMINATING TOPCOAT FROSTING:

| | | |
|---|---|---|
| TRIETHANOLAMINE, 99% | 0.05 | 0.50 |
| Totals: | 99.97 | 917.96 |

The epoxy modified acrylic intermediate in this example includes:

| Lbs. | Gals. |
|---|---|
| 32.790 | 3.860 RE0948, an epoxy modified acrylic solution and a |
| | trademark of Akzo Nobel |
| 1.950 | 0.200 METHYLON 75108, a phenolic resin solution and a |
| | trademark of OCCIDENTAL CHEMICAL/DUREZ |
| 0.280 | 0.030 TRIETHANOLAMINE, 99% obtained from |
| | Dow Chemicals |
| 0.110 | 0.020 NACURE 4167 a catalyst of blocked acid phosphate and a |
| | trademark of KING INDUSTRIES |

QC Film Application:

| Applicator: | | 12-14 DDB |
|---|---|---|
| Primer: | | NA |
| Substrate: | | HDG (hot dipped galvanized) |
| Topcoat: | | CERAM-A-STAR ® 950 |
| | | (a siliconized polyester and trademark of |
| | | Akzo Nobel) |
| Air Dry: | | 0.00 |
| Heat: | | 0° F. for |
| Bake: | | 550° F. for 6 SEC |
| PMT Temp: | | 230° F. |
| (peak metal | | |
| temperature) | | |
| Thickness | Dry: | 0.25 ± 0.05 MIL |
| | Wet: | 0.70 ± 0.18 MIL |

Quality Control Data:

| | |
|---|---|
| Flexibility: | IT-2T NTO (no tape off) |
| Grind Fineness: | 7.00 ± 0.00 |
| Hardness: | F H |
| Device: | PENCIL |
| Solvent Resist: | 5-15 MEK |
| Impact: | 80 IN/LB NTO (no tape off) |
| pH: | 9.20 to 9.60 |
| Solids: | 36.16 ± 1.00% wt |
| WPG: | 9.18 ± 0.15 LBS/GL |
| Viscosity: | 17-23 SEC@77° F. |
| | #4 ZAHN |
| Red Visc: | -@0° F. |
| Red Agent: | WATER |
| VOC: | 1.91 lbs/gallon |

In the flexibility test, the coated metal is bent and then a piece of 3m 610 tape is applied to the bend and then rapidly pulled away. Upon examination of the tape, no paint particles were found(no tape off or NTO).

In the impact test, the coated metal is bent and then a piece of 3m 610 tape is applied to a reverse impact bump and then rapidly pulled away. Upon examination of the tape, no paint particles were found (no tape off or NTO).

Special Instructions:

0.019 HDG PT1500 (pretreat 1500): #12-14 DDB (draw down bar); IR BAKE 3 MAX ENERGY; LAB BAKE 6 @550 F. PMT 230 F.

### Example 2

| | Standard | |
|---|---|---|
| Item | Gal. | lbs. |

ADD THE FOLLOWING TO A CLEAN STAINLESS
STEEL VESSEL. ADD IN
ORDER UNDER HSD.

| | | |
|---|---|---|
| NEOREZ R-9637 | 19.76 | 173.93 |
| DREWPLUS L-483 | 0.11 | 0.79 |
| SURFYNOL 465 SURFACTANT | 0.50 | 4.35 |

MIX FOR 30 MINUTES THEN ADD THE
FOLLOWING UNDER HSD:

| | | |
|---|---|---|
| AEROSIL 200 | 0.04 | 0.75 |
| STRONTIUM CHROMATE 176 | 1.53 | 47.83 |
| TIONA RCL-6 | 0.48 | 15.66 |

MIX FOR 30 MINUTES THEN PROCESS
THROUGH SANDMILL TO 7.0 NS.
RINSE WITH THE FOLLOWING:

| | | |
|---|---|---|
| DEIONIZED WATER | 2.09 | 17.39 |

2^{ND} RINSE:

| | | |
|---|---|---|
| DEIONIZED WATER | 2.09 | 17.39 |

LETDOWN WITH THE FOLLOWING UNDER
CONTINUOUS AGITATION ON LOW SPEED:

| | | |
|---|---|---|
| NEOREZ R-9637 | 46.05 | 405.27 |

ADD NEXT ITEM SLOWLY INTO THE VORTEX:

| | | |
|---|---|---|
| TRIETHANOLAMINE, 99% | 0.52 | 4.91 |

MIX FOR 15 MINUTES THEN CONTINUE:

| | | |
|---|---|---|
| CYMEL 328 | 2.93 | 30.07 |
| EPOXY MOD. ACRYLIC INTERMEDIATE | 4.12 | 35.25 |
| TRIETHYLAMINE | 0.41 | 2.46 |
| DEIONIZED WATER | 15.05 | 125.33 |

MIX 15 MINUTES THEN CONTINUE:

| | | |
|---|---|---|
| TRITON GR-7M SURFACTANT | 1.13 | 9.51 |
| ACRYSOL RM-825 | 0.92 | 7.98 |

RHEOLOGY MODIFIER
HOLD FOR VISCOSITY ADJUSTMENT:

| | | |
|---|---|---|
| DEIONIZED WATER | 2.06 | 17.15 |
| ACRYSOL RM-825 | 0.10 | 0.87 |
| RHEOLOGY MODIFIER | | |

HOLD FOR PH ADJUSTMENT:

| | | |
|---|---|---|
| TRIETHANOLAMINE, 99% | 0.11 | 1.00 |
| Totals: | 100.00 | 917.89 |

The epoxy modified acrylic intermediate in this example includes:

| Lbs. | Gals. |
|---|---|
| 32.910 | 3.870 RECA08, an epoxy modified acrylic solution and a |
| | trademark of Akzo Nobel |
| 1.950 | 0.200 METHYLON 75108, a phenolic resin solution and a |
| | trademark of OCCIDENTAL CHEMICAL/DUREZ |
| 0.280 | 0.030 TRIETHANOLAMINE, 99% obtained from |
| | Dow Chemicals |
| 0.110 | 0.020 NACURE 4167 a catalyst of blocked acid phosphate and a |
| | trademark of KING INDUSTRIES |

QC Film Application:

| Applicator: | | 12-14 DDB |
|---|---|---|
| Primer: | | NA |
| Substrate: | | HDG |
| Topcoat: | | CERAM-A-STAR ® 950 |
| | | (a siliconized polyester and trademark of |
| | | Akzo Nobel) |
| Bake: | | 550° F. for 6.00 sec |
| PMT Temp: | | 230° F. |
| Thickness | Dry: | 0.25 +/− 0.05 MIL |
| | Wet: | 0.70 +/− 0.18 MIL |

Quality Control Data:

| | |
|---|---|
| Flexibility: | IT-2T NTO |
| Grind Fineness: | 7.00± |
| Hardness: | F H |
| Device: | PENCIL |
| Solvent Resist: | 5-15 MEK |
| Impact: | 80 IN/LB NTO |
| pH: | 9.2 to 9.6 |
| Solids: | 35.92 ± 1.00% wt |
| WPG: | 9.17 ± 0.15 LBS/GL |
| Viscosity: | 17-23 SEC@77° F. |
| | #4 ZAHN |
| Red Agent: | WATER |

Special Instructions:

0.019 HDG PT1500: #12-14 DDB; IR BAKE 3 MAX ENERGY; LAB BAKE 6 @550 F. PMT 230 F.

### Example 3

| | Standard | |
|---|---|---|
| Item | Gal. | lbs. |

ADD THE FOLLOWING TO A CLEAN STAINLESS
STEEL VESSEL. ADD IN
ORDER UNDER HSD.

| | | |
|---|---|---|
| NEOREZ R-9637 | 20.16 | 177.41 |
| DREWPLUS L-483 | 0.11 | 0.81 |
| SURFYNOL 465 SURFACTANT | 0.51 | 4.44 |

MIX FOR 30 MINUTES THEN ADD
THE FOLLOWING UNDER HSD:

| | | |
|---|---|---|
| AEROSIL 200 | 0.04 | 0.77 |
| STRONTIUM CHROMATE 176 | 1.56 | 48.79 |
| TIONA RCL-6 | 0.49 | 15.97 |

MIX FOR 30 MINUTES THEN PROCESS THROUGH
SANDMILL TO 7.0 NS.
RINSE WITH THE FOLLOWING:

| | | |
|---|---|---|
| DEIONIZED WATER | 2.13 | 17.74 |

2^{ND} RINSE:

| | | |
|---|---|---|
| DEIONIZED WATER | 2.13 | 17.74 |

LETDOWN WITH THE FOLLOWING UNDER CONTINUOUS
AGITATION ON LOW SPEED:

| | | |
|---|---|---|
| NEOREZ R-9637 | 46.97 | 413.38 |

ADD NEXT ITEM SLOWLY INTO THE VORTEX:

| | | |
|---|---|---|
| TRIETHANOLAMINE, 99% | 0.53 | 5.01 |

MIX FOR 15 MINUTES THEN CONTINUE:

| | | |
|---|---|---|
| CYMEL 328 | 2.99 | 30.67 |
| EPOXY MOD. ACRYLIC INTERMEDIATE | 3.72 | 31.83 |

MIX 15 MINUTES THEN CONTINUE:
ADD NEXT ITEM SLOWLY INTO THE VORTEX:

| | | |
|---|---|---|
| TRIETHYLAMINE | 0.41 | 2.51 |
| DEIONIZED WATER | 15.35 | 127.84 |

MIX 15 MINUTES THEN CONTINUE:

| | | |
|---|---|---|
| TRITON GR-7M SURFACTANT | 1.15 | 9.70 |
| ACRYSOL RM-825 | 0.94 | 8.14 |
| RHEOLOGY MODIFIER | | |

HOLD FOR VISCOSITY ADJUSTMENT:

| | | |
|---|---|---|
| DEIONIZED WATER | 2.48 | 20.69 |
| ACRYSOL RM-825 | 0.10 | 0.89 |
| RHEOLOGY MODIFIER | | |

HOLD FOR PH ADJUSTMENT:

| | | |
|---|---|---|
| TRIETHYLAMINE | 0.17 | 1.02 |
| Totals: | 101.94 | 935.35 |

The epoxy modified acrylic intermediate in this example includes:

| Lbs. | Gals. |
|---|---|
| 29.450 | 3.460 RE0948 an epoxy modified acrylic solution |
| | and a trademark |
| | of Akzo Nobel |
| 1.990 | 0.210 METHYLON 75108, a phenolic resin solution and a |
| | trademark of OCCIDENTAL CHEMICAL/DUREZ |
| 0.280 | 0.030 TRIETHANOLAMINE, 99% obtained from |
| | Dow Chemicals |
| 0.110 | 0.020 NACURE 4167 a catalyst of blocked acid phosphate and a |
| | trademark of KING INDUSTRIES |

QC Film Application:

| | |
|---|---|
| Applicator: | 12-14 DDB |
| Primer: | NA |
| Substrate: | HDG |
| Topcoat: | CERAM-A-STAR ® 950 |
| | (a siliconized polyester and trademark of |
| | Akzo Nobel) |
| Air Dry: | 0.00 |
| Heat: | 0° F. for |
| Bake: | 550° F. for 6 SEC |
| PMT Temp: | 230° F. |
| Thickness Dry: | 0.25 ± 0.05 MIL |
| Wet: | 0.70 ± 0.18 MIL |

Quality Control Data:

| | |
|---|---|
| Flexibility: | IT-2T NTO |
| Grind Fineness: | 7.00 ± 0.00 |
| Hardness: | F H |
| Device: | PENCIL |
| Solvent Resist: | 5-15 MEK |
| Impact: | 80 IN/LB NTO |
| pH: | 9.20 to 9.60 |
| Solids: | 35.54 ± 1.00% wt |
| WPG: | 9.17 ± 0.15 LBS/GL |
| Viscosity: | 17-23 SEC@77° F. |
| | #4 ZAHN |
| Red Visc: | -@0° F. |
| Red Agent: | WATER |

Special Instructions:

0.019 HDG PT1500: #12-14 DDB; IR BAKE 3 MAX ENERGY; LAB BAKE 6 @550 F. PMT 230 F.

In the above formulation examples:
CYMEL 328 is a melamine crosslinker and a trademark of Cytec;
DREWPLUS L-483 is a defoamer which is a blend of organic material and hydrocarbons and a trademark of DREW INDUSTRIAL DIVISION/ASHLAND CHEMICALS;
SURFYNOL 465 is a surfactant of mixed diols and a trademark of AIR PRODUCTS;
AEROSIL 200 is a fumed silica extender pigment and a trademark of DEGUSSA;
TIONA RCL-6 is a titanium dioxide pigment and a trademark of MILLENIUM SPECIALTY;
NEOREZ R-9637 is a polyurethane dispersion (PUD) and a trademark of NEORESINS/AVECIA;
TRITON GR-7M is a surfactant/flow additive of sulfosuccinate and a trademark of DOW CHEMICAL;
ACRYSOL RM-825 is a rheology modifier/thickener of a polyurethane solution and a trademark of ROHM AND HAAS;
RE0948 is an epoxy modified acrylic (acrylic-grafted epoxy) solution and a trademark of AKZO NOBEL;
METHYLON 75108 is a phenolic resin solution and a trademark of OCCIDENTAL CHEMICAL/DUREZ;
NACURE 4167 is a catalyst of blocked acid phosphate and a trademark of KING INDUSTRIES; and
RECA08 (2W712) is an epoxy modified acrylic (acrylic-grafted epoxy) solution and a trademark of AKZO NOBEL.

The application recommendations for the formulations are:

| | |
|---|---|
| Reducer: | water |
| Lab baking cycle: | 6 sec. @ 550° F. |
| Peak metal temp: | 230 to 245° F. |
| Wet film, mils.: | 0.69 to 1.04 |
| Dry film, mils.: | 0.20 to 0.30 |

### Example 4

The formulation of example 3 was coated on galvanized steel on a coil coating line (CCL) and cured in a 2 meter induction oven for about 2.4 to about 3 seconds to reach a peak metal temperature of about 110° C. to about 119° C. The line speed was 50 meters per minute and the coating was applied over BONDERITE 1303 (complex oxide chemical treatment)/BONDERITE 62 (chromate rinse sealer) treated HDG. The panel evaluation and salt spray results are shown in tables 1 and 2 below.

TABLE 1
Panel evaluation results.

| | DFT | | | | | |
|---|---|---|---|---|---|---|
| | (mils) | MEK | PENCIL | FLEX | REV IMP* 80 in/lb | Gloss @ 60° |
| Black Topcoat | | | | | | |
| Prime Only (Top) | 0.13 | 100+ | 4H+ | 0T | NTO | 25.4 |
| Prime Only (Back) | 0.14 | 100+ | 4H+ | 0T | NTO | 17.1 |
| With Topcoat (total) | 0.85 | 200+ | F | 2T | NTO | 18.5 |
| With Gray Backer (total) | 0.38 | 100+ | 3H | 2T | NTO | 38.2 |
| White Topcoat | | | | | | |
| Prime Only (Top) | 0.13 | 100+ | 4H+ | 0T | NTO | 20.3 |
| Prime Only (Back) | 0.19 | 100+ | 4H+ | 0T | NTO | 16.3 |
| With Topcoat (total) | 0.96 | 200+ | F | 1T | NTO | 54.7 |
| With Gray Backer (total) | 0.38 | 100+ | 3H | 2T | NTO | 44.8 |

*REV IMP is reverse impact; NTO is no tape off

TABLE 2

| | Salt Spray | | | |
|---|---|---|---|---|
| Trial No. | Hours | Blister | Corrosion | Observation |
| 1 | 0 | | | none |
| | 250 hs | 10 | no | none |
| | 500 hs | 9 | no | penetration 1 mm lateral, |
| | | | | no corrosion |
| | 1000 hs | 9 | no | penetration 2 mm lateral, |
| | | | | no corrosion |
| | SNOW WHITE COIL | | | |
| 2 | 0 | | | none |
| | 264 | 10 | no | none |
| | 500 hs | 9-8 | no | penetration 1 mm lateral, |
| | | | | no corrosion |
| | 1000 hs | 9-8 | no | penetration 2 mm lateral, |
| | | | | no corrosion |
| | MATTE BLACK COIL | | | |
| 3 | 0 H | | | none |
| | 216 H | 10 | no | none |
| | 500 H | 10 | no | none |
| | 700 H | 10 | no | none |
| | 1000 H | 9 | no | 1 mm lateral y |
| | | | | 1 mm < scratch |
| | SNOW WHITE COIL | | | |
| 4 | 0 H | | | none |
| | 216 H | 10 | no | none |
| | 500 H | 10 | no | none |
| | 700 H | 10 | no | none |
| | 1000 hs | 9 | no | 1 mm lateral |

MATTE BLACK COIL

### Example 5

The formulation of Example 1 was cured in a near infrared (NIR) oven. The NIR range was in the 0.8 to 1.5 microns (12500cm⁻¹ to 6667cm⁻¹) region of the electromagnetic spectrum. The results are shown in Table 3 below.

TABLE 3

| | | | | | | | | | CONVENTIONALLY |
|---|---|---|---|---|---|---|---|---|---|
| | | | | | | | | | CURED |
| | | | EMITTER**** | LINE | | PYROMETER | PMT | MEK | CERAM-A-STAR ® |
| TRIAL | | PRIMER | HEIGHT | SPEED | DWELL | READING | TAPE | DB | 950 |
| NO. | SUBSTRATE | CURE METHOD | (cm) | (m/mni) | TIME (s) | (° F.) | (° F.) | RUBS | TOPCOAT |
| 1 | .015″ B1310 | NIR | 20.0 | 10.5 | 1.43 | 242.0 | 330 | 30-40 | EXCELLENT |
| | GLUM* | | | | | | | | APPEARANCE |
| 2 | .015″ B1310 | NIR | 20.0 | 10.5 | 1.43 | 237.0 | 330 | 30-40 | EXCELLENT |
| | GLUM | | | | | | | | APPEARANCE |
| 3 | .015″ B1310 | NIR | 20.0 | 16.0 | 0.94 | 221.0 | 270 | WEAK | EXCELLENT |
| | GLUM | | | | | | | 15 | APPEARANCE |
| 4 | .015″ B1310 | NIR | 20.0 | 16.0 | 0.94 | 224.4 | 270 | WEAK | EXCELLENT |
| | GLUM | | | | | | | 15 | APPEARANCE |
| 5 | .015″ B1303 | NIR | 20.0 | 14.0 | 1.07 | 256.0 | 330 | 30-40 | EXCELLENT |
| | HDG** | | | | | | | | APPEARANCE |
| 6 | .015″ B1303 | NIR | 20.0 | 14.0 | 1.07 | 249.6 | 330 | 30-40 | EXCELLENT |
| | HDG | | | | | | | | APPEARANCE |
| 7 | .015″ B1303 | NIR | 20.0 | 20.0 | 0.75 | 223.0 | 270 | MOD | EXCELLENT |
| | HDG | | | | | | | 15 | APPEARANCE |
| 8 | .015″ B1303 | NIR | 20.0 | 20.0 | 0.75 | 216.8 | 270 | MOD | EXCELLENT |
| | HDG | | | | | | | 15 | APPEARANCE |
| 9 | .015″ B1310 | CONVENTIONAL*** | NA | NA | 5 | NA | 310-320 | <10 | EXCELLENT |
| | GLUM | | | | | | | | APPEARANCE |
| 10 | .015″ B1310 | CONVENTIONAL | NA | NA | 3 | NA | 260-270 | <10 | SEVERE |
| | GLUM | | | | | | | | FROSTING |
| 11 | .015″ B1303 | CONVENTIONAL | NA | NA | 5 | NA | 310-320 | <10 | EXCELLENT |
| | HDG | | | | | | | | APPEARANCE |
| 12 | .015″ B1303 | CONVENTIONAL | NA | NA | 3 | NA | 260-270 | <10 | SEVERE |
| | HDG | | | | | | | | FROSTING |

22 s @ 560° F. => 450° F. PMT
*BONDERITE 1310 (phosphate based conversion coating pretreatment from Henkel Surface Technologies) GLUM (GALVALUME ® (zinc/aluminum coating))
**BONDERITE 1303 (phosphate based conversion coating pretreatment from Henkel Surface Technologies) HDG (hot dipped galvanized)
***Conventional primer cure method was an electric forced air oven where temperatures are maintained at 560° F.
****Super burn emitters (power consumption = 4,400 Watts) were the type of lamps used in the NIR (near-infrared) unit
CERAM-A-STAR ® 950 is a top coat available from Akzo Nobel

1. A composition comprising a polyurethane or polyurea dispersion, triethanolamine, one or more crosslinkers, and an epoxy and/or acrylic resin.

2. The composition of claim 1, wherein the epoxy and/or acrylic resin is an epoxy acrylate solution, acrylic modified epoxy, or an epoxy modified acrylic.

3. The composition of claim 1, wherein the triethanolamine is present in an amount effective to reduce the wrinkling of a topcoat which is applied on top of the composition.

4. The composition of claim 1, wherein the one or more crosslinkers are melamine, blocked isocyanate, and/or phenolic resin; the epoxy and/or acrylic resin is acrylic modified epoxy; and the resin ratios in the composition, based on resin solids by weight, are about 70% to about 90% polyurethane or polyurea dispersion, about 2.6% to about 3.2% acrylic modified epoxy, about 10.3% to about 10.7% melamine, and up to about 2% phenolic resin.

5. A composition made by combining a polyurethane or polyurea dispersion, melamine, triethanolamine, and an epoxy and/or acrylic resin.

6. The composition of claim 5, wherein the epoxy and/or acrylic resin is an epoxy acrylate solution, acrylic modified epoxy, or an epoxy modified acrylic.

7. The composition of claim 5, wherein the triethanolamine is present in an amount effective to reduce the wrinkling of a topcoat which is applied on top of the composition.

8. The composition of claim 5, wherein the epoxy and/or acrylic resin is acrylic modified epoxy; and the resin ratios in the composition, based on resin solids by weight, are about 70% to about 90% polyurethane or polyurea dispersion; about 2.6% to about 3.2% acrylic modified epoxy; about 10.3% to about 10.7% melamine; and further comprising up to about 2% phenolic resin.

9. A method of coating metal on a first line comprising galvanizing the metal on the first line and thereafter pre-treating the galvanized metal on the first line with a composition made by combining a polyurethane or polyurea dispersion, one or more crosslinkers, and an acrylic modified epoxy resin, and then placing the metal on a second line for coating with one or more additional compositions.

10. The method of claim 9, wherein, in the composition, the one or more crosslinkers are melamine, blocked isocyanate, and/or phenolic resin; the epoxy and/or acrylic resin is acrylic modified epoxy; and the resin ratios in the composition, based on resin solids by weight, are about 70% to about 90% polyurethane or polyurea dispersion, about 2.6% to about 3.2% acrylic modified epoxy, about 10.3% to about 10.7% melamine, and up to about 2% phenolic resin.

11. A method of protecting metal comprising applying thereto a composition made by combining a polyurethane or polyurea dispersion, melamine, triethanolamine, and an epoxy and/or acrylic resin.

12. The method of claim 11, wherein the epoxy and/or acrylic resin is an epoxy acrylate solution, acrylic modified epoxy, or an epoxy modified acrylic.

13. The method of claim 11, further comprising applying a topcoat on top of the composition, and wherein the triethanolamine is present in the composition in an amount effective to reduce the wrinkling of the topcoat.

14. The method of claim 11, wherein the epoxy and/or acrylic resin is acrylic modified epoxy; and the resin ratios in the composition, based on resin solids by weight, are about 70% to about 90% polyurethane or polyurea dispersion; about 2.6% to about 3.2% acrylic modified epoxy; about 10.3% to about 10.7% melamine; and further comprising up to about 2% phenolic resin.
